(19) United States
(12) Patent Application Publication
(10) Pub. No.: US 2010/0095117 A1
(43) Pub. Date: Apr. 15, 2010

(54) SECURE AND POSITIVE AUTHENTICATION ACROSS A NETWORK

(76) Inventor: Michael C. Shebanow, Saratoga, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/252,248

(22) Filed: Oct. 15, 2008

(51) Int. Cl. H04L 9/00

(52) U.S. Cl. 713/168

(57) ABSTRACT

One embodiment takes the form of a method for authenticating an identity of a first party to a second party, without any prior contact between the parties. Further, the first party may authenticate its identity to the second party while eliminating the ability of the second party to steal the first party's identity. A trusted authority may facilitate authenticating the identity of two or more communicating parties. In one embodiment, the authority may ensure the validity of the identification of a number of parties talking over a communications network. The parties communicating over the secure network trust what the authority states concerning the identities of the other parties in the network. Another embodiment may prevent the authority from monitoring which two parties are communicating to each other through the network.

### BACKGROUND

The internet is a globally ubiquitous link between peoples of the world. The World Wide Web (WWW), built on top of the internet, is used for commerce, communication, messaging and a host of other applications. For the most part, protocols such as HTTPS enable relatively secure communications. However, secure and positive identification between strangers remains a significant problem. This in turn leads to problems such as identity theft, where some party spoofs being another party to a third party. A solution to the problem of identity theft may provide a solution to problems such as sexual predators in online chat rooms, the lack of verifiable electronic signatures, and spam emails.

Thus, what is needed is a way that a sender and a recipient may interact safely without the requirement of a prior contact and without the fear that the recipient could steal the identity of the sender.

### BRIEF SUMMARY OF THE INVENTION

One embodiment may be a method for facilitating certification of a first party's identity to a second party. The method may include depositing information from a first party in a secure access point maintained by a trusted intermediary. The trusted intermediary may further certify the identities of the first party and the second party. The method may also include providing the information to the second party upon a request by the second party.

A second embodiment may also be a method for a first party to certify its identity to a second party. This embodiment may include storing data and an identity of the first party in a plurality of storage locations implemented by a trusted intermediary. The method may also include supplying, to the second party, the data and the identity stored in at least one of the plurality of storage locations. Further, the trusted intermediary may certify the identity of the first party.

A third embodiment may be a method for facilitating certification of a first party's identity to a second party including depositing a first key of a key pair into a secure access point, where the secure access point is maintained by a trusted intermediary. The method may also include transmitting a first message to the second party to retrieve the first key from the trusted intermediary, receiving a second message from the second party that the first key is retrieved and instructing the trusted intermediary to remove the first key from the secure access point. The method may further include receiving a third message from the trusted intermediary that the first key has been removed, encrypting a fourth message using a second key of the key pair and sending the fourth message to the second party.

A fourth embodiment may be an apparatus for facilitating certification of a first party's identity to a second party. The apparatus may comprise a plurality of addressable storage locations, with each storage location configured to store data provided by a first party. The apparatus may also include a supplier module configured to provide the stored data from any storage location and the identity of the party that stored the data in that storage location to the second party. Finally, the apparatus may also include an identifier module configured to verify the identity of the first party and the second party.

### BRIEF DESCRIPTION OF THE DRAWINGS

FIG. 1 depicts one embodiment of the present invention depicting a secure communications network.

FIG. 2 depicts a flowchart of one embodiment of the present invention.

FIG. 3a depicts a first step of an embodiment of the present invention that requires fewer communications between the parties.

FIG. 3b depicts a second step of an embodiment of the present invention that requires fewer communications between the parties.

FIG. 4 depicts one embodiment of the present invention providing an alternate arrangement of mailboxes.

### DETAILED DESCRIPTION OF THE INVENTION

One embodiment of the present invention takes the form of a method for authenticating an identity of a first party to a second party. Through the embodiment, a party may authenticate its identity without any prior contact between the parties. After authentication, a secure connection may be established between the parties that allow the parties to communicate freely without fear of that one party may be falsely representing their identity. Further, through the embodiment, the first party may authenticate its identity to the second party without the ability of the second party to spoof the first party's identity to a third party.

A trusted authority may facilitate authenticating the identity of two or more communicating parties. In one embodiment, the authority may ensure the validity of the identification of a number of parties communicating over a network. The parties communicating over the secure network trust what the authority states concerning the identities of the other parties in the network. Another embodiment may effectively prevent the authority from monitoring which two parties are communicating to each other through the network. It should be noted that the term “network” encompasses any method in which parties can communicate, including, but not limited to: the internet, an Ethernet, a wide-area network, a local-area network, a wireless network, a telephone system, a postal service, and so forth.

In one embodiment, a first party may wish to authenticate its identity to a second party. The first party may create a public/private encryption key pair and deposit the public key with a trusted authority that may verify the identity of the first party. The second party may then retrieve the public key from the authority. Upon retrieval of the public key by the second party, the first party may encrypt a message using the private key of the key pair and send the encrypted message to the second party. The second party may then decrypt the encrypted message using the public key, thereby creating a secure communication link in which the identity of the first party has been authenticated to the second party by virtue of the fact that the public key was retrieved from a trusted intermediary that has authenticated the source of the public key.

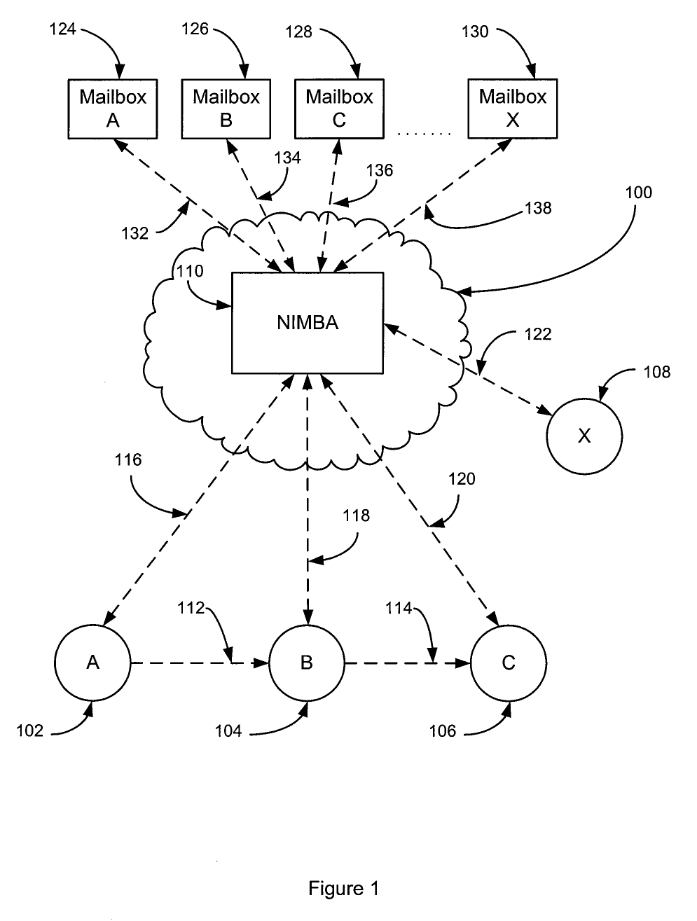

FIG. 1 depicts one embodiment of the present invention depicting a secure communications network 100. Party A 102, party B 104 and party C 106 may be attached to and communicate over the communications network 100. The communications network may be configured to host any number of parties, represented by party X 108. It should be appreciated that the communications network 100 may be configured to allow any number of parties connected to the network 100 to communicate with each other. Alternatively, the network 100 may be configured to provide for communication between smaller subsets of parties, or subnetworks. For example, in FIG. 1, parties A, B and C may form a subnetwork, meaning that parties A, B and C may communicate with each other over the network. In another example, parties A and B may form a subnetwork while parties C and X may form a separate subnetwork. The configurations of the network and subnetworks may take on many possible variations.

In the embodiment depicted in FIG. 1, party A 102 may communicate with party B 104 over the communications network through virtual connection 112. Further, party A 102 may wish to authenticate its identity to party B 104 such that party B 104 may trust that all later correspondence from party A 102 can be trusted to come from party A 102. Party A 102 may also desire that any authentication information sent to party B 104 cannot be later used by party B 104 to mislead party C 106 via virtual connection 114 into believing that party B 104 is party A 102. Furthermore, party A 102 may not have communicated previously with party B 104.

To ensure a secure communication between party A 102 and party B 104, the communications network 100 may provide a trusted third party, the “network identity and mailbox authority” (NIMBA) 110. NIMBA 110 may certify the identity of a population of parties communicating over the communication network. Further, NIMBA 110 may also directly communicate with the population of parties. For example, NIMBA 110 may communicate with party A 102 via virtual connection 116, party B via connection 118, party C via connection 120, and party X via virtual connection 122. NIMBA 110 may also implement and communicate with a series of mailboxes 124-130 via connections 132-138. Alternatively, NIMBA 110 may physically implement the series of mailboxes 124-130 internally. If the series of mailboxes 124-130 are implemented internally within NIMBA 110, then connections 132-138 may be operable connections between NIMBA 110 and mailboxes 124-130. If the mailboxes are implemented separately from NIMBA 110, connections 132-138 may be network connections connecting the mailboxes 124-130 to NIMBA 110. As described in greater detail below, a mailbox may be created for each party connected to the communications network 100 to assist in the authentication of the party's identity.

The NIMBA may be implemented in many forms. In one example, the NIMBA may be a single entity that performs the described functions. In another example, the NIMBA may be implemented in a peer-to-peer manner. In this example, a network of NIMBAs may communicate with and trust each other over the network. Each NIMBA may manage a subset of the client population of the network or the client populations of each NIMBA may overlap. In another example, the NIMBA may be implemented in a hierarchical manner with super-NIMBAs overseeing sub-NIMBAs. Generally, any network configuration may be used to implement the functions of the NIMBA as described in reference to the Figures.

As mentioned above, NIMBA 110 may authenticate the identity of a population of parties communicating over the communications network 100. For example, NIMBA 110 may authenticate party A's 102 identity and party B 104 and party C 106 can trust that such information is true. The method by which NIMBA 110 authenticates the identity of a party connected to the communications network 100 may take many forms. For example, a secure communication channel between NIMBA 110 and a party may be established, whereby the party may send NIMBA 110 a password previously agreed upon between them. Alternatively, the party may be forced to appear in person and provide paper documentation establishing their identity. Upon presenting the proper documentation, the party may be issued a piece of hardware trusted by the management entity of NIMBA 110. The hardware may then be installed on a computing apparatus that is connected to the communication network 100 and may be used to communicate encrypted information only to NIMBA 110. Other options include biometrics to establish a person's identity, a smart card issued to the user, or a combination of all of the above. It should be appreciated that many varied methods exist to authenticate the identity of a party communicating over the communication network 100 to NIMBA 110. Generally, however, the NIMBA 110 may communicate with any party via a secure and accurate link.

As shown in FIG. 1, NIMBA 110 may implement a set of mailboxes 124-130. Each party connected to the communication network 100 may be provided a mailbox 124-130 by NIMBA 110. For example, party A 102 may be assigned mailbox A 124, party B 104 may be assigned mailbox B 126, party C 106 may be assigned mailbox C 128, etc. Each party connected to the communications network 100 may provide information to NIMBA 110 to be stored within their own assigned mailboxes 124-130. NIMBA 110 may then accept the information and store it in the mailbox assigned to the party that sent the information. Generally, NIMBA 110 will only allow a party to store information in its own assigned mailbox. However, NIMBA 110 may provide the information stored in the mailboxes 124-130 to other parties connected to the communications network 100 upon receiving a request for access to a particular mailbox. NIMBA 110 may directly provide the information stored in the mailbox or it may provide a copy of the information stored in the mailbox and maintain the original information in the mailbox for future use. In this embodiment, the parties connected to the communications network 100 send and store encryption keys. However, the mailboxes 124-130 may store any type of information provided by the parties connected to the communications network 100.

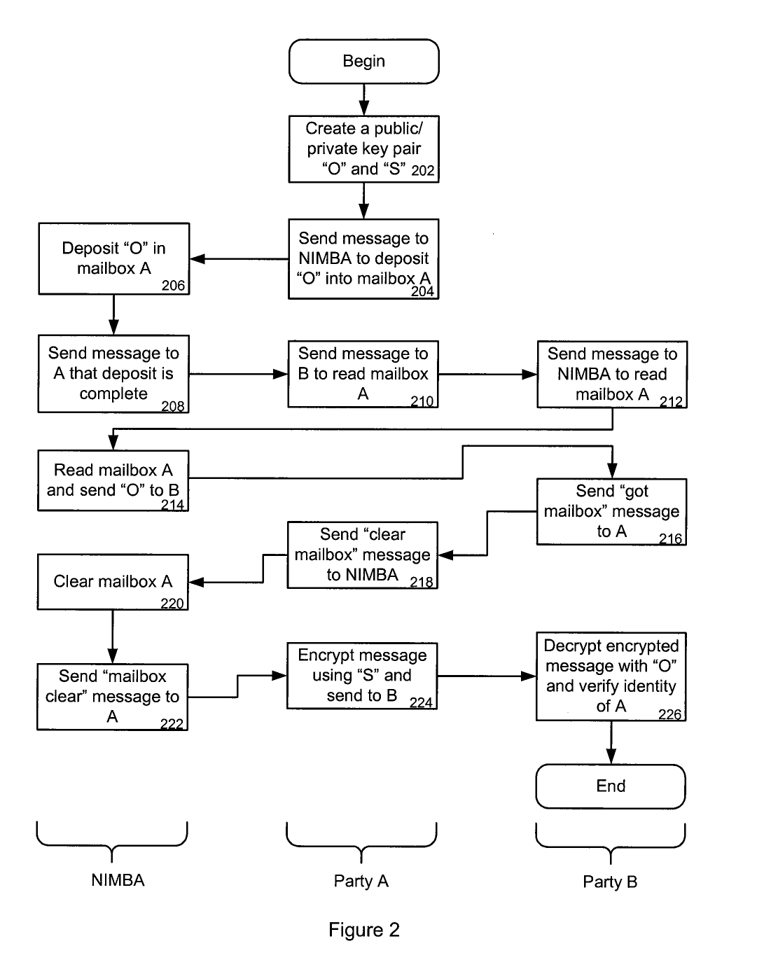

FIG. 2 depicts a flowchart of one embodiment of the present invention. Referring to FIGS. 1 and 2, this embodiment allows party A 102 to authenticate itself to party B 104 without ever having previously communicated with party B 104 while preventing party B 104 from stealing its identity.

In operation 202, party A 102 may begin by creating a public/private encryption key pair. In this example, the public encryption key is labeled “O” (open) while the private encryption key is labeled “S” (secret). As with traditional public/private key encryption, the public key may be provided to the public while the private key may be retained by the key pair creator. After the creation of the key pair, party A 102 may send a message via connection 116 to NIMBA 110 to deposit the public key “O” in a mailbox 124 assigned to party A 102 in operation 204. As previously described, NIMBA 110 may create a secure connection to each party of the communications network 100. Through these secure connections 116-120, NIMBA 110 can receive information from the parties and deposit that information into the corresponding mailbox of that party. The secured connections 116-120 may also allow NIMBA 110 to ensure that the information contained in each mailbox was sent by the party to whom the mailbox is assigned.

Upon receiving the public key “O” from party A 102 over the secured connection 116, NIMBA 110 may deposit the key in mailbox A 124 in operation 206. After depositing “O” in mailbox A 124, NIMBA may send a message back to party A 102 via secured connection 116 that the information was deposited in mailbox A 124 in operation 208.

Assuming party A 102 desires to authenticate itself and communicate securely with party B 104, party A 102 may send a message to party B 104 via connection 118 to contact NIMBA 110 to read the contents of mailbox A 124 in operation 210. If party B 104 desires to authenticate party A 102, party B 104 may then contact NIMBA 110 via connection 118 to obtain the contents of mailbox A 124 in operation 212.

In operation 214, NIMBA 110 may read the contents of mailbox A 124 and send a copy of that information to party B 104 via connection 118. In this embodiment, NIMBA 110 reads the private key “O” in mailbox A 124 and provides “O” to party B 104 via secure connection 118 in operation 214.

Upon receipt of the contents of mailbox A 124, party B 104 may send a message back to party A 102 via connection 112 in operation 216 indicating that party B 104 received the contents of mailbox A 124 from NIMBA 110. In operation 218, party A 102 sends a “clear mailbox” message to NIMBA 110 via connection 116. In operation 220, NIMBA 110 clears mailbox A 124 and, in operation 222, sends a message to party A 102 via connection 116 that mailbox A 124 has been cleared.

Party A 102 may now establish a secure communication with party B 104 via connection 112. On this link, party A 102 may encrypt a message using private key “S” and send the encrypted message to party B 104 in operation 224. In operation 226, party B 104 may receive the encrypted message and decrypt it using public key “O”. The contents of the encrypted message is irrelevant so long as party B 104 knows what message to expect from party A 102 once it decrypts the message using key “O”. In one example, party A 102 may encrypt the message “I am A” using private key “S” and send the encrypted message to party B 104.

At this point, a secured communication link is established between party A 102 and party B 104. Party A 102 may then send more information on this link without encrypting the message using the public/private key pair, since the link is secure and it is established in the mind of party B 104 that party A 102 is the party sending the information to party B 104. However, party A may continue to encrypt the information being sent to party B 104 for added security.

Through the embodiment depicted in FIG. 2, party A's 102 identity is authenticated to party B 104. Since party B 104 acquired public key “O” from NIMBA 110, it knows that party A 102 placed the key there since it trusts NIMBA's assertion that the mailbox contents were indeed placed there by party A 102. Party B 104 also knows upon decrypting the “I am A” message that only party A 102 could have generated it, since only party A 102 has the private key “S” that matches the public key “O”. Furthermore, party B 104 cannot use either the encrypted or decrypted message to spoof the identity of party A 102 to a third party, since the public key “O” is no longer located in mailbox A 124 for retrieval by the third party at the time party B 104 receives the “I am A” message. Consequently, party B 104 cannot tell party C 106 “I am A” in either encrypted or decrypted form that party C 106 would believe, so the message sent by party A 102 is useless as a means for party B 104 to later impersonate party A. Further, by clearing the public key from mailbox A 124 before sending the encrypted message to party B 104, the public/private key pair becomes “use once”, where each pair can only be used for one identification session. Clearing the public key “O” from mailbox A 124 before sending the encrypted message eliminates a race condition that may otherwise provide a window for man-in-the-middle security attacks.

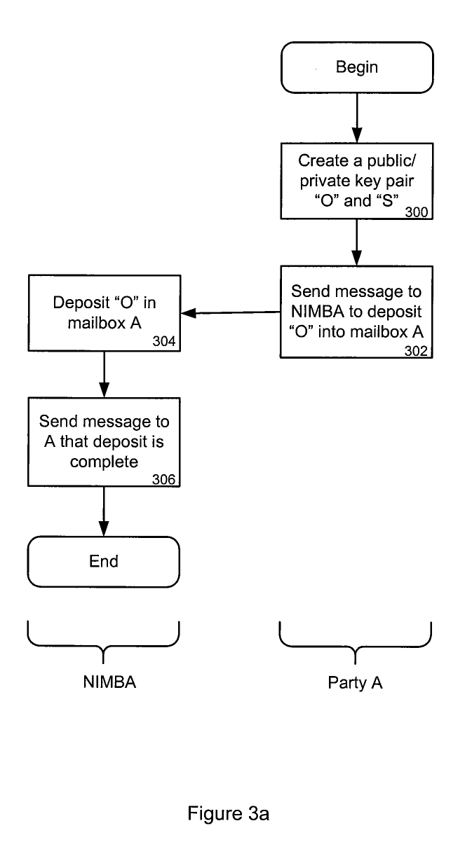

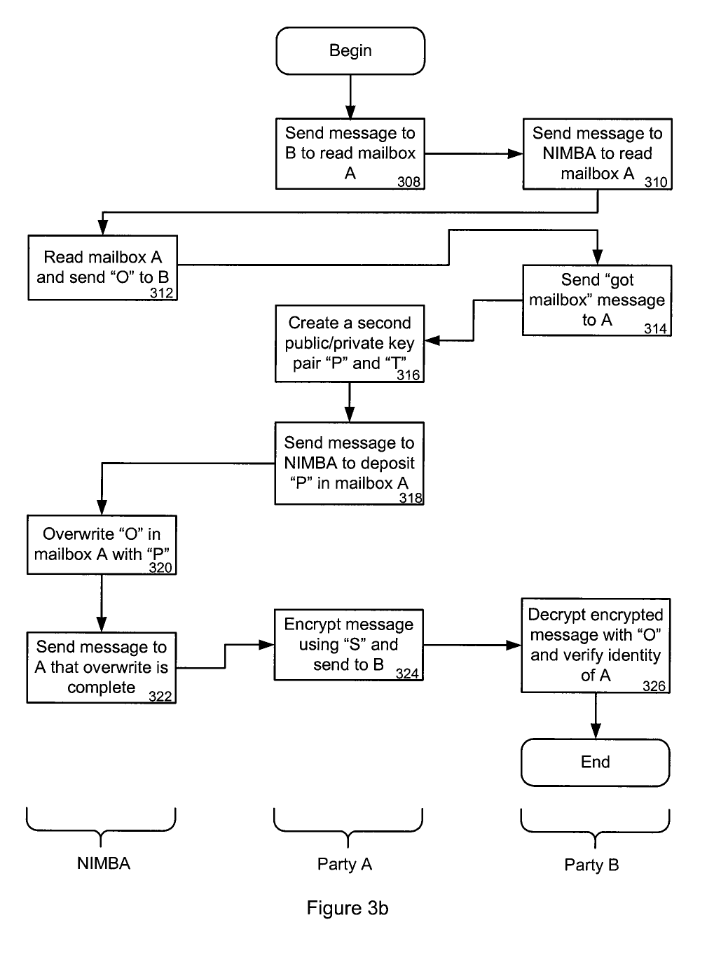

FIGS. 3a and 3b depict another embodiment of the present invention that may require fewer communications between the parties connected to the communications network 100. Similar to the embodiment depicted in FIG. 2, this embodiment may begin in operation 300 by party A 102 creating a first public/private encryption key pair. In this example, the public encryption key of the first key pair is labeled “O” while the private encryption key of the first key pair is labeled “S”. After the creation of the key pair, party A 102 may send a message via connection 116 to NIMBA 110 to deposit the public key “O” in a mailbox 124 assigned to party A in operation 302. Upon receiving the public key “O” from party A 102 over the secured connection 116, NIMBA 110 may deposit the key in mailbox A 124 in operation 304. After depositing “O” in mailbox A 124, NIMBA 110 may send a message back to party A 102 via secured connection 116 that the information was deposited in mailbox A 124 in operation 306.

FIG. 3b depicts the operations that may allow party A 102 to securely identify itself to party B 104. It should be appreciated that the operations of FIG. 3b may occur at any time after the operations of FIG. 3a. Thus, party A may immediately notify party B that “O” is available upon completion of the operations of FIG. 3a or wait any amount of time before performing the operations of FIG. 3b. Similar to the embodiment depicted in FIG. 2, party A 102 may send a message to party B 104 to read mailbox A 124 in operation 308. Party B 104 may then send a message to NIMBA 110 to retrieve the contents of mailbox A 124 in operation 310. NIMBA 110 may then read the contents of mailbox A 124 and send the contents to party B 104 in operation 314. Party B 104 may then send a message to party A 102 indicating that the contents of mailbox A 124 has been received in operation 314.

At this point, instead of clearing mailbox A 124, party A 102 may create a second public/private encryption key pair in operation 316, labeled here as “P” (public key) and “T” (private key). Party A 102 may then send a message via connection 116 to NIMBA 110 to deposit the public key “P” of the second key pair in mailbox A 124 in operation 318. In operation 320, NIMBA 110 may overwrite public key “O” of the first key pair currently stored in mailbox A 124 with public key “P” of the second key pair. NIMBA 110 may then send a message to party A 102 that public key “O” has been overwritten by public key “P” in operation 322. By replacing the first public key “O” stored in mailbox A 124 with public key “P” instead of just clearing the mailbox, the public key “P” is preloaded for the next identification session initiated by party A 102. Thus, through this embodiment, the number of communications between party A102 and NIMBA 110 per identification session is reduced. As a result, the authentication process may take less time and may create less network congestion as the number of necessary communications is reduced.

As before, party A 102 may then encrypt a message using private key “S” and send the encrypted message to party B 104 in operation 324. Party B 104 may then decrypt the message using public key “O” to verify the identity of party A 102 in operation 326. As stated above, at the conclusion of this identification session, public key “P” is now “on-deck” and ready for the party A's 102 next identification session.

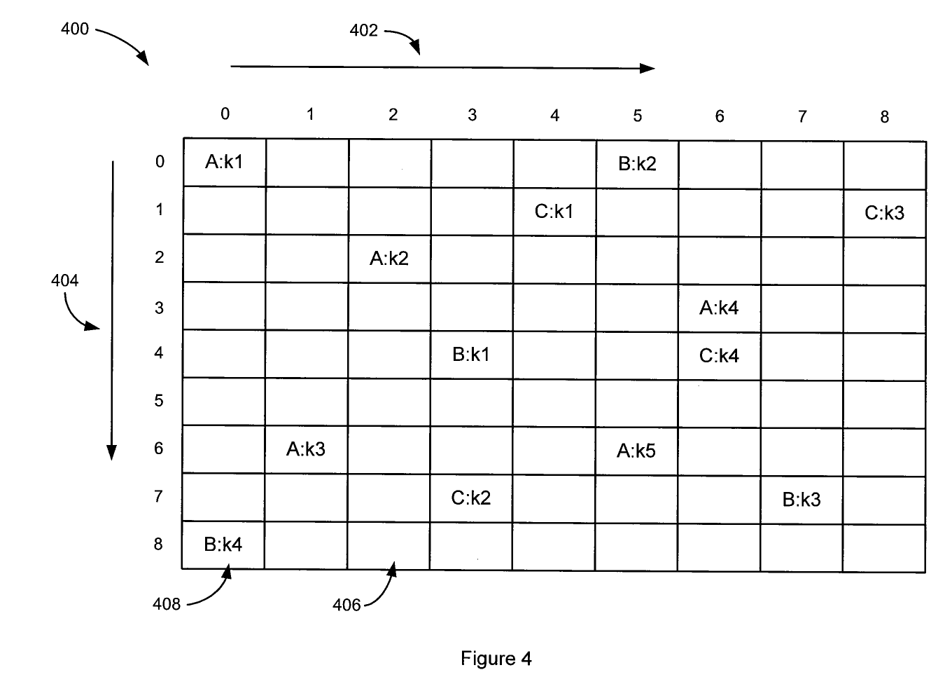

FIG. 4 depicts another embodiment of the present invention that adds another level of security to the above procedures. One possible negative characteristic of the previously described embodiments is that NIMBA 110 may monitor all of the authentication attempts by any party communicating through the communications network 100. Such information may potentially compromise the privacy of the communicating parties. However, the embodiment of FIG. 4 may help prevent NIMBA 110 from monitoring the authentication attempts.

In this embodiment, NIMBA 110 may provide multiple mailboxes for the parties communicating over the communications network 100. Instead of providing one mailbox per party, NIMBA 110 may allow any party on the network 100 to address any number of mailboxes and place information in those mailboxes. FIG. 4 depicts one possible configuration of the mailboxes 400 provided by NIMBA 110. While FIG. 4 depicts the configuration of the mailboxes in a grid pattern, it should be appreciated that the mailboxes may be configured in any manner suitable to provide multiple mailboxes for the parties communicating over the communications network 100.

In the embodiment depicted in FIG. 4, the mailboxes of the network are arranged in a grid pattern. The mailboxes may be addressed based on an X-axis 402 and a Y-axis 404. Each cell in the grid may be addressed using an X/Y pair of numbers. For example, mailbox 406 may be addressed using the X/Y pair 2/8.

Each addressable mailbox may contain information sent by a party and an identification of the party depositing information into the mailbox. For example, mailbox 408 may be addressed by the X/Y pair 0/8. Within mailbox 408 may be a “party:key” pair signifying the party that wrote information to the mailbox and the information that was placed there. In this example, party B 104 deposited public key 4 to the mailbox. Thus, the mailbox may indicate this through the party:key pair “B:k4”. As with the previous embodiments, only NIMBA 110 may read and write to the mailboxes. Further, NIMBA may guarantee the identity of the parties that last stored any information in any of the mailboxes.

In this embodiment, a party may send information to randomly generated mailboxes. For example, in FIG. 4, party A 102 generates potentially valid public keys k1-k5 to mailboxes 0/0, 2/2, 1/6, 6/3 and 5/6, respectively. Similarly, a party connected to the communications network 100 may read the contents of randomly selected mailboxes. For example, party B 104 may request the contents of all of the mailboxes with X addresses 0-4 and Y addresses 0-4. In this example, party B 104 would receive mailboxes containing A:k1, A;k2 and B:k1.

When party A 102 desires to authenticate its identity to party B 104, party A 102 may generate a public/private key pair similar to the previous embodiments. Party A 102 may then deposit the public key in a randomly chosen mailbox. For example, party A 102 may deposit public key 4 in mailbox 6/3. Party A 102 may then inform party B 104 of the mailbox in which the public key is deposited. Party B 104 may then request the contents of multiple mailboxes in the immediate area of the public key it desires, including the desired mailbox. Thus, in this example, party B 104 may request the contents of multiple mailboxes around mailbox 6/3. Once the public key is retrieved, authentication proceeds as described in the previous embodiments.

Through this embodiment, the privacy of party A 102 and party B 104 is preserved to the degree that the true mailbox exchange between the parties is obscured by the random reads and writes of the parties prior to the true exchange. As long as multiple parties read the mailboxes written to by party A 102, NIMBA 110 may be unaware of which parties are communicating over the communications network 100. Instead, the true exchange of information may appear as a random set of reads and writes. However, this embodiment may increase the number of communications that take place over the communications network 100. The numerous random reads and writes to mask the true exchange may require multiple communications between the parties and NIMBA 110. However, the added security to the communication between the parties may be worth the added communications.

Another embodiment may include a computing device that may include a processor configured to perform the methods of the NIMBA described above. Similarly, a computing device may be included in the embodiment with a processor configured to perform the methods of party A and/or party B. Alternatively, a computer readable medium may be configured to perform the methods of each party of the embodiment. Such computer-readable media can be any available media that can be accessed by a general purpose or special purpose computer. By way of example, and not limitation, such computer-readable media can comprise RAM, ROM, EEPROM, DVD, CD ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications link or connection (either hardwired, wireless, or a combination of hardwired or wireless) to a computer, the source of the information can be properly viewed as a computer-readable medium, such as a server, a storage medium, a processor, and the like.

Combinations of the above should also be included within the scope of computer-readable media. Computer-executable instructions comprise, for example, instructions and data which cause a general purpose computer, special purpose computer, or special purpose processing device to perform a certain function or group of functions.

Resident on the computing devices of the network, including NIMBA, party A and party B, may be several modules to perform the above described methods. These modules may include computer-executable instructions stored in the processor of each computing device or in a computer-readable medium. Each module may perform one or several of the above mentioned operations. For example, NIMBA may include a module that identifies the parties of the network. Thus, the module may receive some type of identification from each party to the network and store the parties identity. In this manner, the modules resident on network parties may perform the methods described above.

It should be noted that the flowcharts of FIGS. 2, 3a and 3b are illustrative only. Alternative embodiments of the present invention may add operations, omit operations, or change the order of operations without affecting the spirit or scope of the present invention.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

What is claimed is:

1. A method for facilitating certification of a first party's identity to a second party, comprising:
depositing electronic information from a first party in a secure access point maintained by a trusted intermediary;
certifying the identities of the first party and the second party; and
after certifying the identities, providing the information to the second party upon a request by the second party.

2. The method of claim 1 wherein the information is a first key from a key pair.

3. The method of claim 2 wherein the first party creates the key pair.

4. The method of claim 1 wherein the trusted intermediary certifies to the second party that the information was supplied by the first party.

5. The method of claim 1 wherein the trusted intermediary stores information on behalf of the first party and the second party.

6. The method of claim 2 further comprising:
removing the first key from the secure access point upon receiving the request from the second party.

7. The method of claim 6 wherein the removing operation comprises:
replacing the first key from the first key pair with a second key from a second key pair, the second key pair being created by the first party.

8. The method of claim 1 further comprising:
verifying the identity of the first party.

9. A computer-implemented method for facilitating certification of a first party's identity to a second party, comprising:
implementing, by a trusted intermediary, a plurality of electronic storage locations;
storing data from the first party and the identity of the first party in a subset of the plurality of storage locations; and
providing the stored data and the identity stored in at least one of the plurality of storage locations to a requesting party;
wherein the trusted intermediary certifies the identity of the first party.

10. The computer-implemented method of claim 9 wherein the plurality of storage locations are addressed by an outside party and identifies the last party to store data in the plurality of storage locations.

11. The computer-implemented method of claim 9 wherein the storing of the data in the plurality of storage locations is restricted to a first subset of storage locations.

12. The computer-implemented method of claim 9 wherein the reading of the data in the plurality of storage locations is restricted to a second subset of storage locations.

13. The computer-implemented method of claim 9 wherein the data is a first key of a key pair.

14. A method for facilitating certification of a first party's identity to a second party comprising:
depositing a first electronic key of a key pair into a secure access point, the secure access point maintained by a trusted intermediary;
transmitting a first message to the second party to retrieve the first key from the trusted intermediary;
receiving a second message from the second party that the first key is retrieved;
instructing the trusted intermediary to remove the first key from the secure access point;
receiving a third message from the trusted intermediary that the first key has been removed;
encrypting a fourth message using a second key of the key pair; and
sending the fourth message to the second party.

15. The method of claim 14 wherein the first party creates the key pair.

16. The method of claim 14 wherein the trusted intermediary certifies to the second party that the first key was stored by the first party.

17. The method of claim 14 wherein the depositing operation comprises: depositing a plurality of first keys of a plurality of key pairs into a plurality of secure access points, each secure access point maintained by the trusted intermediary.

18. The method of claim 14 wherein the second party decrypts the fourth message using the first key of the key pair.

19. An apparatus for facilitating certification of a first party's identity to a second party comprising:
a plurality of addressable storage locations, each storage location configured to store data provided by a first party;
a supplier module configured to provide the stored data from any storage location and the identity of the party that stored the data in that storage location to the second party; and
an identifier module configured to verify the identity of the first party and the second party.

20. The apparatus of claim 19 wherein the data is a first key of a key pair.
